(19) United States
(12) Patent Application Publication
(10) Pub. No.: US 2017/0243579 A1
(43) Pub. Date: Aug. 24, 2017

(54) ELECTRONIC APPARATUS AND SERVICE PROVIDING METHOD THEREOF

(71) Applicant: Samsung Electronics Co., Ltd., Suwon-si (KR)

(72) Inventors: Woo-seok HWANG, Seoul (KR); ln-ji KIM, Seoul (KR); Young-eun KIM, Suwon-si (KR); Ji-soo KIM, Goyang-si (KR); Ji-yeon PARK, Suwon-si (KR); Bong-chan CHO, Suwon-si (KR)

(73) Assignee: Samsung Electronics Co., Ltd., Suwon-si (KR)

(21) Appl. No.: 15/437,733

(22) Filed: Feb. 21, 2017

(30) Foreign Application Priority Data
Feb. 19, 2016 (KR) 10-2016-0019543

(51) Int. Cl. G10L 15/22; G10L 15/02; G10L 25/51; G10L 25/84

(52) U.S. Cl. CPC G10L 15/22; G10L 25/84; G10L 15/02; G10L 25/51; G10L 2015/226

(57) ABSTRACT

An electronic apparatus and a service providing method thereof are provided. The service providing method includes receiving a sound generated from outside through at least one microphone, extracting a noise feature from the received sound, and providing a service corresponding to the extracted noise feature by comparing the extracted noise feature and a pre-stored noise feature.

### CROSS-REFERENCE TO RELATED APPLICATIONS

This application claims priority from Korean Patent Application No. 10-2016-0019543, filed in the Korean Intellectual Property Office on Feb. 19, 2016, the disclosure of which is incorporated herein by reference in its entirety.

### BACKGROUND

1. Field

Apparatuses and methods consistent with exemplary embodiments broadly relate to an electronic apparatus and a service providing method thereof, and more particularly, to an electronic apparatus which provides service by extracting a noise feature from a surrounding sound and a service providing method thereof.

2. Description of the Related Art

The technique of an electronic apparatus providing service suitable for a surrounding environment recognized by recognizing a surrounding environment of an electronic apparatus is developing in recent years with the development of sensing technology and the development of communication technology.

According to the related art, a surrounding environment is recognized according to whether a user is nearby at a house and by capturing an image using a camera. However, when a surrounding context is recognized by an image, the surrounding context may not be accurately predicted, thereby causing a privacy problem. In addition, when an image having a high resolution is analyzed for accurate prediction, the amount of calculation to process the image is increased and a complexity of algorithm is increased.

Accordingly, a more efficient and accurate method for providing service is by recognizing context information of an electronic apparatus without a user manipulation is required.

### SUMMARY

Additional aspects and/or advantages will be set forth in part in the description which follows and, in part, will be apparent from the description, or may be learned by practice of the embodiments.

One or more exemplary embodiments provide an electronic apparatus, which extracts a noise feature based on a sound received through at least one microphone, and provides a service by analyzing the extracted noise feature, and a service providing method thereof.

One or more embodiments provide a service providing method of an electronic apparatus including receiving a sound through at least one microphone, extracting a noise feature from the received sound, determining a change of the noise feature by comparing the extracted noise feature with a previously-extracted noise feature, and recommending a service corresponding to the determining change of the noise feature, and performing the recommended service based on a user input.

The recommending may include determining a type of noise feature by comparing the extracted noise feature with a pre-stored noise feature, and recommending a service by determining context information based on the determined type of noise feature and a type of a previously-extracted noise feature.

The recommending may include, in response to determining, as a result of determining the change of the noise feature, that a human noise has been generated by a person at a house where the electronic apparatus is located, recommending a music providing service.

The recommending may include, in response to determining, as a result of determining the change of the noise feature, that a device noise has been generated by a device at a house where the electronic apparatus is located, recommending a music providing service in view of a volume of the device noise.

The recommending may include recommending music by determining a genre or volume of music being provided, according to a volume of the noise.

The recommending may include, in response to determining, as a result of determining the change of the noise feature, that an environment noise has been generated outside a house where the electronic apparatus is located, recommending an information providing service corresponding to the environment noise.

The above-mentioned method may include, in response to a plurality of microphones being provided, determining a location of a sound source which generates the sound based on a sound received through the plurality of microphones, and the recommending may include recommending a service by determining the context information based on the determined location of the sound source.

The recommending may include, in response to not extracting a noise feature for a predetermined time and extracting a pre-stored noise feature, recommending a guide service in response to the extracting of the noise feature.

The sound generated from outside and the user input may be received by a remote controller for controlling the electronic apparatus.

According to an embodiment, an electronic apparatus may include at least one microphone which receives a sound generated from outside, a processor which extracts a noise feature from the received sound, determines a change of the noise feature by comparing the extracted noise feature with a previously-extracted noise feature, and recommends a service corresponding to the determined change of the noise feature, and a functional unit which performs the recommended service according to a user input.

The processor may determine a type of noise feature by comparing the extracted noise feature and a pre-stored noise feature, and recommend a service by determining context information based on the determined type of the noise feature and a previously-determined type of noise feature.

The processor may, as a result of determining the change of the noise feature, that a human noise has been generated by a human at a house where the electronic apparatus is located, recommends a music providing service.

The processor may, in response to determining, as a result of determining the change of the noise feature, that a device noise has been generated by a device at a house where the electronic apparatus is located, recommends a music providing service in view of a volume of the device noise.

The processor may determine a genre or volume of music being provided, according to a volume of the noise.

The processor may, in response to determining, as a result of determining the change of the noise feature, that an environment noise has been generated outside a house where the electronic apparatus is located, recommends an information providing service corresponding to the environment noise.

The processor may, in response to a plurality of microphones being provided, determine a location of a sound source which generates the sound based on a sound received through the plurality of microphones, and recommends a service by determining the context information based on the determined location of the sound source.

The processor may, in response to not extracting a noise feature for a predetermined time and extracting a pre-stored noise feature, recommend a guide service in response to the extracting of the noise feature.

The sound generated from outside and the user input may be received by a remote controller for controlling the electronic apparatus.

One or more embodiments provide a non-transitory computer readable storage medium storing a service providing method of an electronic apparatus, the method including receiving sound through at least one microphone, extracting a noise feature from received sound, determining a change of the noise feature by comparing an extracted noise feature with a previously-extracted noise feature, and recommending a service corresponding to a determined change of the noise feature and performing a recommended service based on a user input.

One or more embodiments provide a service providing method of an electronic apparatus, the method including obtaining sound, recognizing a context of the sound, recommending a service corresponding to the context, and performing the service based on a user input.

According to the various embodiments of the present disclosure, the electronic apparatus may analyze a surrounding sound to extract a noise feature, thereby more accurately and promptly recognizing a surrounding context to provide a service.

### BRIEF DESCRIPTION OF THE DRAWINGS

The above and other aspects of one or more exemplary embodiments will become more apparent by reference to specific embodiments thereof which are illustrated in the appended drawings. Understanding that these drawings depict only exemplary embodiments of the disclosure and are not therefore to be considered to be limiting of the scope of the disclosure, the principles herein are described and explained with additional specificity and detail through the use of the accompanying drawings, in which:

FIG. 1 is a block diagram briefly illustrating a configuration of an electronic apparatus, according to an embodiment;

FIG. 2 is a block diagram illustrating a detailed configuration of an electronic apparatus, according to an embodiment;

FIG. 3 is a block diagram which includes a plurality of modules for an electronic apparatus to perform a service providing method, according to an embodiment;

FIG. 4 is a flowchart explaining a service providing method according to a type of noise feature, according to an embodiment;

FIGS. 5A to 6 are views illustrating messages being displayed on a screen, according to various embodiments; and

FIG. 7 is a flowchart explaining a service providing method of an electronic apparatus, according to an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the by referring to the figures.

Certain exemplary embodiments will now be described in greater detail with reference to the accompanying drawings.

The terms used in the example embodiments of the present disclosure are general terms which are widely used now and selected considering the functions of the present disclosure. However, the terms may vary depending on the intention of a person skilled in the art, a precedent, or the advent of new technology.

In an embodiment of the present disclosure, ‘a module’ or ‘a unit’ performs at least one function or operation and may be realized in hardware or software or a combination thereof. In addition, a plurality of ‘modules’ or ‘units’ may be integrated into at least one module and may be realized as at least one process or processor (not shown) except for ‘modules’ or ‘units’ that should be realized in specific hardware.

Hereinbelow, certain exemplary embodiments will now be described in greater detail with reference to the accompanying drawings to enable those skilled in the art to work the same with ease. However, exemplary embodiments may be realized in a variety of different configurations, and not limited to descriptions provided herein. Further, those that are irrelevant with the description are omitted so as to describe exemplary embodiments more clearly, and similar drawing reference numerals are used for the similar elements throughout the description.

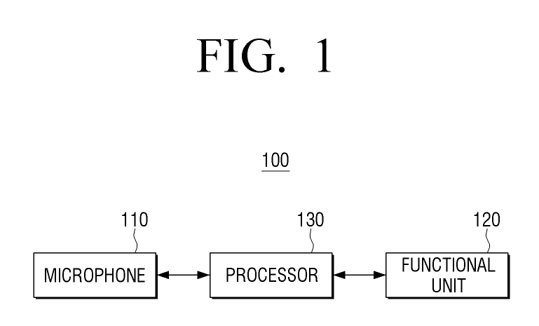

Hereinafter, the present disclosure will be explained in further detail with reference to the drawings attached. FIG. 1 is a block diagram briefly illustrating a configuration of an electronic apparatus, according to an embodiment. As illustrated in FIG. 1, an electronic apparatus 100 includes a microphone 110, a functional unit 120 and a processor 130. According to an embodiment, the electronic apparatus 100 may be a display apparatus of which the location is fixed, such as a smart TV, desktop PC, kiosk, refrigerator, washing machine, or the like. However, this is merely an example. It may be realized as a portable display apparatus such as a smartphone, tablet PC, notebook PC, wearable device, or the like.

The microphone 110 receives a sound generated from an external source. In this example, the microphone 110 may be included in the electronic apparatus 100. However, this is merely an example. It may also be included outside the electronic apparatus 100 (e.g. a remote controller for controlling the electronic apparatus 100 and an external device communicatively connected to the electronic apparatus 100). For example, there may be a plurality of microphones 110. In addition, the microphone 110 may be realized as a sound sensor which detects audio.

The functional unit 120 performs a multimedia function of the electronic apparatus 100 according to a control of the processor 130. For example, the functional unit 120 may be realized as a display for outputting a guide message, and may be realized as a speaker for providing a music providing service.

The processor 130 controls an overall operation of the electronic apparatus 100. For example, the processor 130 may extract a noise feature from a sound received from the microphone 110, determine a change of the noise feature by comparing the extracted noise feature with a previously-extracted noise feature, and determine context information corresponding to the change of the noise feature to provide a suitable service. In this example, the context information may include context information of a user using the electronic apparatus 100, context information within a house where the electronic apparatus 100 is located, and context information outside the house where the electronic apparatus 100 is located.

For example, the electronic apparatus 100 may maintain a standby mode where some of the features of the electronic apparatus 100 (e.g. display, speaker, etc.) are in an inactivated state or in an off state.

Also, while maintaining the standby mode, the processor 130 may, in response to a sound being input, extract a noise feature from the sound.

In addition, the processor 130 may determine a type of the extracted noise feature by comparing the extracted noise feature with a pre-stored noise feature. In this example, a type of extracted noise feature may include a human noise which is generated by a person within a house where the electronic apparatus 100 is located, a device noise which is generated by a device within a house where the electronic apparatus 100 is located, and an environment noise which is generated outside a house where the electronic apparatus 100 is located. However, this is merely an example and it may include other noise, such as animal noise or the like.

In addition, the processor 130 may determine context information based on a type of the extracted noise feature and a type of a previously-extracted noise feature to provide a service corresponding to a noise feature. For example, as a result of determining the change of the noise feature, in response to determining that a human noise (e.g. voice of a person, sound of steps, breathing sound, etc.) has been generated by a person within a house where the electronic apparatus 100 is located, the processor 130 may provide a music providing service by determining context information indicating that a person exists in the house. In this example, a type of music provided by a music providing service may be differently provided according to a person located in the house.

In addition, as a result of determining the change of the noise feature, in response to determining that a device noise has been generated by a device within a house where the electronic apparatus 100 is located, the processor 130 may determine context where a person within the house is currently manipulating the device, to recommend a music providing service based on a type and volume of the device noise. In this example, the processor 130 may determine a genre or volume or catalog of music being provided, according to a volume of the noise.

In addition, as a result of determining the change of the noise feature, in response to determining that an environment noise has been generated outside a house where the electronic apparatus 100 is located, the processor 130 may determine that a particular event (e.g. construction, accident) has occurred outside the house where the electronic apparatus 100 is located, and recommend an information providing service corresponding to the environment noise.

According to an embodiment, when a plurality of microphones 110 are provided, the processor 130 may determine a location of a sound source which generates a sound based on a volume of the sound received through the plurality of microphones. In addition, the processor 130 may provide a service by determining context information based on the determined location of the sound source. For example, if determining that a location of a sound source is living room, the processor 130 may recommend a music providing service through a speaker located in the living room.

In addition, the processor 130 may determine a change of an extracted noise feature by comparing, in real time, the extracted noise feature and a previously-extracted noise feature, and recommend a service by determining a context of a user based on the change of the extracted noise feature. According to an embodiment, while a noise feature has not been extracted for a predetermined time, in response to extracting a pre-stored noise feature (e.g. human noise), the processor 130 may determine that the user has come home from outside, and recommend a guide service in response.

In this example, the processor 130 may provide the determined service recommendation through a display in a visual form. However, this is merely an example. The determined service recommendation may be provided in an auditory form, such as a speaker.

In addition, the processor 130 may control the functional unit 120 to perform the recommended service according to a user input. For example, if a music service is recommended, the processor 130 may control a speaker of the functional unit 120 to perform the recommended music service according to a user input. In this example, the processor 130 may control the functional unit 120 to perform service by activating some features in an inactivated state.

Here, a user input may be an explicit input such as pressing a button of a remote controller. However, this is merely an example. It may be an implicit input such as a user approaching to the electronic apparatus 100 or holding or grabbing a remote controller for controlling the electronic apparatus. That is, if the user intentionally takes an action to control the electronic apparatus 100, the processor 130 may determine the intentional action of the user and control the functional unit 120 to perform a recommended service.

In the above-described embodiments, it is described that a noise is detected while the electronic apparatus 100 maintains a standby mode. However, this is merely an example. The electronic apparatus 100 may detect a noise and provide a service to a user even when the electronic apparatus 100 maintains a normal mode where features of the electronic apparatus are turned on.

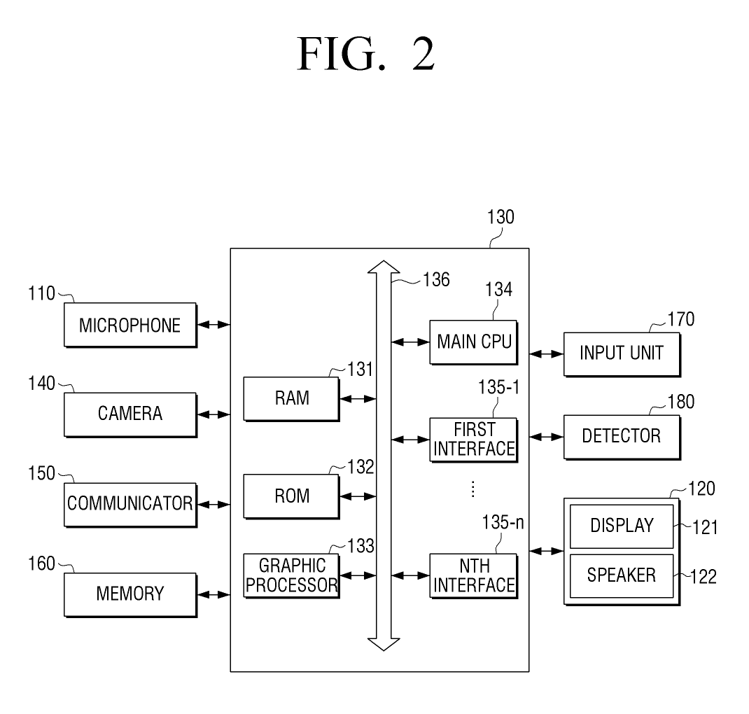

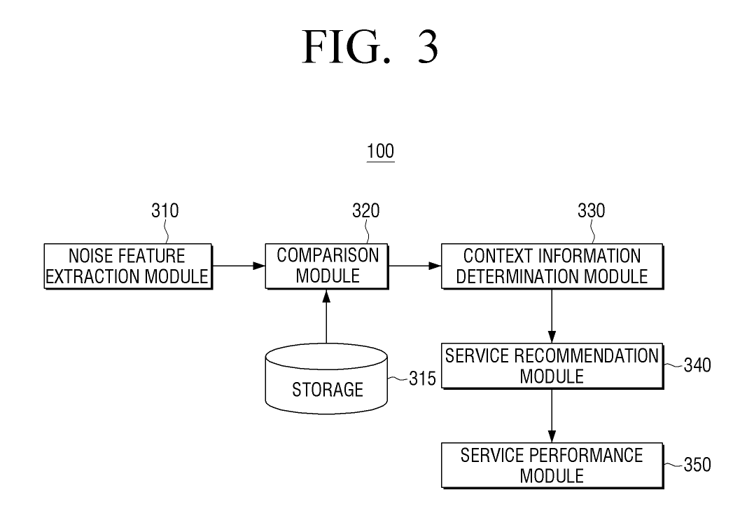

FIG. 2 is a block diagram illustrating a detailed configuration of an electronic apparatus, according to an embodiment. As illustrated in FIG. 2, the electronic apparatus 100 includes a microphone 110, a camera 140, a communicator 150, a memory 160, an input unit 170, a detector 180, a functional unit 120 and a processor 130. However, the above-mentioned features are merely an example and at least one of the aforementioned features may be omitted or other functional units may be added.

The microphone 110 receives a sound generated from an external source. In this example, the microphone 110 may be included in the electronic apparatus 100, and may be included in an external device 100 connected to the electronic apparatus 100 via cable or wirelessly. For example, if a plurality of microphones are provided, to determine a location of a sound source, a location of the microphone 110 may be determined.

The camera 140 captures an image of outside. For example, the camera 140 may capture an image to provide the image to the processor 130 so that the processor 130 recognizes context information more accurately. For example, while a noise feature is not detected for a predetermined time, in response to detecting a noise feature, the processor 130 may control the camera 140 to turn on the camera 140 to capture outside.

The communicator 150 communicates with an external apparatus. For example, the communicator 150 may include various communication chips, such as W-Fi chip, Bluetooth chip, NFC chip, wireless communication chip, or the like. In this case, the Wi-Fi chip, the Bluetooth chip and the NFC chip perform communication according to a LAN method, a Wi-Fi method, a Bluetooth method, and an NFC method, respectively. In the case of the Wi-Fi chip or the Bluetooth chip, various connection information, such as subsystem identification (SSID) and a session key, may be transmitted/received first for communication connection, and then various information may be transmitted/received. A wireless communication chip may refer, for example, to a chip that communicates according to various communication protocols, such as an IEEE, a ZigBee, a 3rd Generation (3G), a 3rd Generation Partnership (3GP), a Long Term Evolution (LTE), and the like.

For example, the communicator 150 may transmit a control command to an external apparatus when performing service according to the determined context information. In addition, the communicator 150 may receive various information (e.g. accident information, construction information) from an external server via Internet.

The memory 160 stores various modules to drive the electronic apparatus 100. For example, the memory 160 may store software including a base module, a sensing module, a communication module, a presentation module, a web browser module and a service module. In this example, the base module is a basic module which processes a signal transmitted from each piece of hardware included in the electronic apparatus 100 and transmits the signal to an upper layer module. The sensing module is a module which collects information from various sensors to analyze and manage the collected information, which may include a face recognition module, a voice recognition module, a motion recognition module, an NFC recognition module, etc. The presentation module is a module which constitutes a display screen, which may include a multimedia module for reproducing multimedia content and output the content and a UI rendering module which performs a UI and graphic processing. The communication module is a module for communicating with an external device. The web browser module refers to a module which performs web browsing and accesses a web server. The service module refers to a module that includes various applications for providing diverse services.

In addition, the memory 160 may include a plurality of modules for extracting a noise feature from a sound generated from an external sound source and providing a service. For example, the memory 160, as shown in FIG. 3, includes a noise feature extraction module 310, a comparison module 320, a context information determination module 330, a service recommendation module 340 and a service performance module 350. In addition, the memory 150 may include a database 315 which stores various types of noise features to detect a type of extracted noise feature.

For example, the noise feature extraction module 310 may extract a noise feature from a received sound. In this example, the noise feature may be an audio feature having a predetermined frequency and a signal pattern in an audio signal. In addition, the comparison module 320 may compare the extracted noise feature with a noise feature pre-stored in the database 315. In this example, the database 315 may store a pre-stored type of noise feature, which may be stored at manufacturing. However, this is merely an example. It may be received through a server or acquired through a noise feature training model.

In addition, the context information determination module 330 may determine a type of extracted noise feature, a location of a sound source which generates a sound from which a noise feature is extracted, a change of a noise feature, etc., and determine context information.

In addition, the service recommendation module 340 determines service and recommends the service to a user based on the determined context information. In this example, the service recommendation module 340 may recommend service in a visual form. However, this is merely an example, the service may be recommended in an auditory form.

In addition, the service performance module 350 may perform the recommended service according to a user input. For example, the service performance module 350 may analyze not only an explicit input by a user but also an intentional motion of the user to control the electronic apparatus 100 (e.g. A motion to hold a remote controller, a motion to gaze the electronic apparatus 100 for a predetermined time, etc.) to perform a recommended service. In this example, the service performance module 350 may perform a service which provides visual information such as a guide message or the like, and perform a service which provides auditory information such as playing music or the like.

As described above, the memory 160 may include various program modules; however, various program modules may be omitted, modified or added according to a type or characteristics of the electronic apparatus 100. For example, if the above-mentioned display apparatus 200 is realized as a tablet PC, the basic module may further include a position determination module for determining a GPS-based position and the sensing module may further include a sensing module which detects a movement of a user.

The memory 160 may be realized, as non-limiting examples, as various volatile or non-volatile memory.

The input unit 170 receives a user command to control the electronic apparatus 100. For example, the input 170 may be realized as a remote controller, but this is merely an example. It may be realized as other input devices to control the electronic apparatus 100, such as a pointing device, a mouse, a keyboard, a voice recognition apparatus, a motion recognition apparatus, a touch panel, or the like.

The detector 180 includes various sensors to detect surrounding context of the electronic apparatus 100. For example, the detector 180 may include a proximity sensor which detects approaching of an object, a temperature sensor and a humidity sensor, which detect a temperature and humidity of a house where the electronic apparatus 100 is located. However, the example is not limited thereto.

In addition, the detector 180 may be included outside the electronic apparatus 100 to communicate with the electronic apparatus 100. In this example, the detector 180 may be a feature of the electronic apparatus 100, but may be included in another electronic apparatus.

The functional unit 120 is a configuration for performing various functions of the electronic apparatus 100. For example, the functional unit 120 includes a display 121 and a speaker 123 as shown in FIG. 2, to perform a multimedia providing service. The display 120 may display a guide message corresponding to an extracted noise feature, etc., and the speaker 123 may output music corresponding to the extracted noise feature. However, the display 121 and the speaker 123 illustrated in FIG. 2 are merely an example. Other functional units (e.g. external apparatus connection interface, etc.) may be included as well.

The processor 130 may be configured to control an overall operation of the electronic apparatus 100 using various programs stored in the memory 160.

The processor 130 includes a RAM 131, ROM 132, a main CPU 134, first to nth interface 135-1 to 135-n and bus 136, as shown in FIG. 2. In this example, the RAM 131, the ROM 132, the main CPU 134, the first to nth interface 135-1 to 135-n, etc. may be connected to each other via the bus 136.

The ROM 132 may store a command set, and the like for system booting. When a turn-on command is input and power is supplied, the main CPU 134 copies an operation system (OS) stored in the memory 160 onto the RAM 131 according to the stored command, and executes the OS to boot the system. If the booting is completed, the main CPU 134 copies various application programs stored in the memory 160 to the RAM 131, executes the application program which is copied to the RAM 131, and performs various operations.

The main CPU 134 accesses the memory 160 to perform booting using the OS stored in the memory 160. In addition, the main CPU 134 performs various operations using various programs, contents, data, etc. stored in the memory 160.

The first to the n-th interface 135-1˜135-n, may be connected to the above described elements. One of the above interfaces may be a network interface which is connected to an external apparatus via network.

According to an embodiment, the processor 130 may include a main processor and an auxiliary processor, and while the electronic apparatus 100 maintains a standby state, the auxiliary processor may be operated, and while the electronic apparatus 100 maintains a normal mode, the main processor may be operated.

In addition, the processor 130 may determine context information according to a noise feature using the various modules 310-350 illustrated in FIG. 3, to provide a service. For example, the processor 120 may extract a noise feature from a sound received through the microphone 110, determine context corresponding to the extracted noise feature by comparing the extracted noise feature with a pre-stored noise feature, and control the functional unit 120 to perform a service according to the determined context.

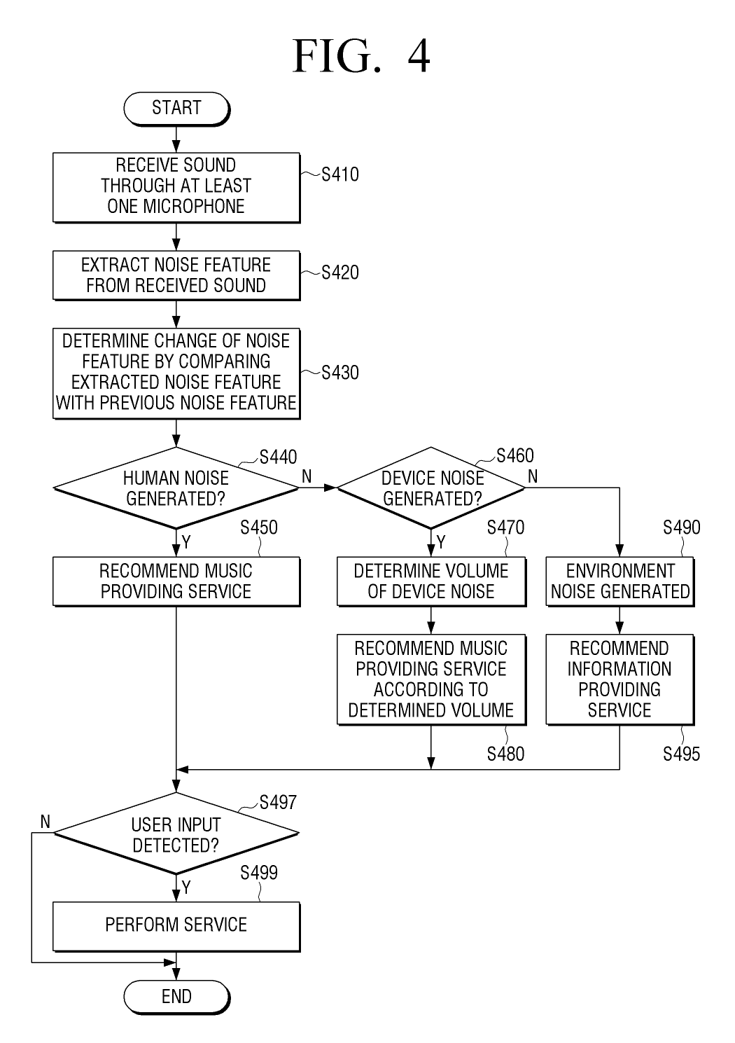

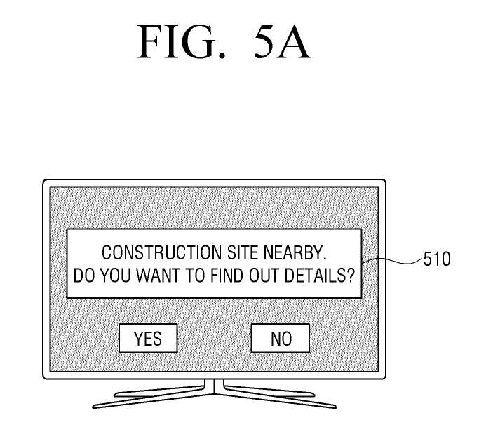

Hereinafter, a method for providing, by the processor 130, service based on a type of a noise feature will be described with reference to FIG. 4.

First, the processor 130 receives a sound through at least one microphone 110, at step S410. For example, the electronic apparatus 100 may activate the microphone 110 in a receipt standby state, and set the other features to an inactivated state. In this state, when a sound is received from an external source, the electronic apparatus 100 may control the processor 130 of the electronic apparatus 100 to be activated.

In addition, the processor 130 extracts a noise feature from the received sound, at step S420. For example, the processor 130 may convert an audio signal in a time area into an audio signal in a frequency area through a T/F conversion. In addition, the processor 130 may analyze a frequency of an audio signal of the frequency area and a signal pattern to extract a noise feature.

In addition, the processor 130 determines a change of noise feature by comparing the extracted noise feature with a previous noise feature. For example, the processor 130 may retrieve a pre-stored noise feature having a frequency and signal pattern that are identical or similar to a frequency and signal pattern of the extracted noise feature. Specifically, when a similarity rate of frequencies and signal patterns of the extracted noise feature and the pre-stored noise feature is greeter than or equal to a pre-stored value, the processor 130 may determine that the extract noise feature and the pre-stored noise feature correspond to each other. In addition, the processor 130 may determine a type of the current extracted noise feature on the basis of a pre-stored noise feature. In this example, a type of noise feature may include a human noise, a device noise, an environment noise, or the like. Although the above embodiments describe that a type of noise feature is a human noise, a device noise and an environment noise, this is merely an example. It may include other noise (e.g. animal noise, etc.). In addition, a type of each noise feature may be further divided. For example, the device noise may be divided into a cleaner noise, an air conditioner noise, or the like, and the human noise may be divided into a noise corresponding to a voice of a first user, a noise corresponding to a second user, or the like, and the environment noise may divided into a construction noise, an ambulance noise, or the like. In addition, the processor 130 may determine context information by comparing a type of the extracted noise feature with a type of a previous noise feature. Thus, the processor 130 may track a change of type of a noise feature in real time to determine the current situation.

When it is determined that a human noise has been generated by the processor 130, the processor 130 may recommend a music providing service corresponding to the human noise according to a preset condition, at step S450. In this example, the processor 130 may determine a detailed type of human noise to recommend a music providing service corresponding to the determined type of the human noise. For example, when it is determined that the type is a human noise corresponding to a first user, the processor 130 may recommend a service which provides music registered by the first user or music frequently listened by the first user. In another example, when it is determined that the type is a human noise corresponding to a second user, the processor 130 may recommend a service which provides music registered by the second user or music frequently listened by the second user.

When it is determined that the type of is not a human noise, No in step S440, the processor 130 may determine whether a device noise has been generated, at step S460.

When it is determined that a device noise has been generated by the processor 130, No in step S460, the processor 130 determines a volume of the device noise, at step S470. In addition, the processor 130 recommends a music providing service according to the determined volume, at step S480. For example, the processor 130, as a volume of device noise gets louder, may increase a volume of music being provided or determine that the provided music is Rock or Dance music. For example, the processor 130, as a volume of device noise gets smaller, may decrease a volume of music being provided or determine that the provided music is Ballad or Classic music. In addition, the processor 130 may recommend a music providing service according to a detailed type of device noise. For example, when the detailed type of device noise is a cleaner noise, the processor 130 may increase a volume of music being provided, and when the detailed type of device noise is an air conditioner noise, the processor 130 may reduce the volume of music being provided.

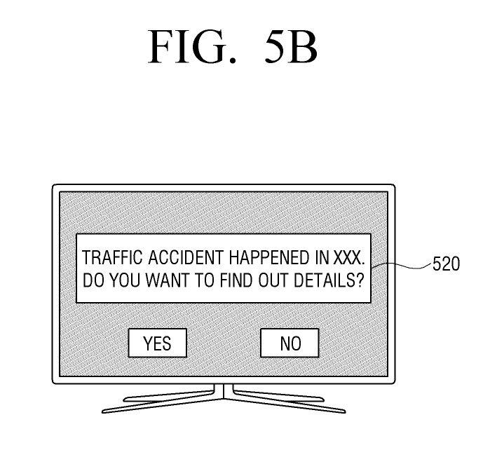

When it is determined that the type is not a device noise, No in step S460, the processor 130 may determine that an environment noise has been generated, at step S490. In addition, the processor 130 recommends an information providing service corresponding to the determined environment noise, at step S495. Specifically, the processor 130 may recommend different information providing service according to a detailed type of the determined environment noise. For example, when the detailed type of environment noise is a construction noise, the processor 130 may control the display 121 to display a construction guide message 510 as shown in FIG. 5A, and when the detailed type of environment noise is an accident noise, the processor 130 may control the display 121 to display an accident guide message as shown in FIG. 5B.

In addition, the processor 130 detects a user input, at step S497. In this example, the processor 130 may detect an explicit input of a user (e.g. an input to select YES or OK in a remote controller). However, this is merely an example. The processor 130 may detect a motion intended by a user to control the display apparatus 100.

When a user input is detected, Yes in step S497, the processor 130 may perform a recommended service according to a user input, at step S499. For example, when the recommended service is a music providing service, the processor 130 may control the speaker 123 to play music based on the determined type and volume of music. In addition, when the recommended service is an information providing service, the processor 130 may control the communicator 150 to receive, from an external server, construction information or accident information in a peripheral area of the electronic apparatus 100, and control the display 121 to provide construction information or accident information based on the received construction information.

In this example, the construction information may include various information, such as construction period, construction location, construction contact information, or the like. In addition, the accident information may include various information, such as accident place, accident time, and detour information, or the like.

In addition, the processor 130 may determine context information using at least one of a location of a sound source and a change of noise, and determine service according to the determined context information to recommend the service.

For example, the processor 130 may determine context information by determining a location of a sound source which generates a noise and a type of noise feature and determine context information, and recommend a service according to the determined context information. For example, if a plurality of microphones 110 are provided, the processor 130 may determine a location of a sound source which generates a noise by comparing volumes of sounds received through the plurality of microphones 110. For example, if microphone A, microphone B and microphone C are provided in a living room, the processor 130 may compare volumes of sounds extracted from each of the sounds received from the microphone A, the microphone B and the microphone C, and as a result of comparison, determine that a sound source is located in the vicinity of a microphone having the loudest volume.

In addition, the processor 130 may recommend a service by determining context information on the basis of the determined location of the sound source and the determined type of noise feature. For example, while a volume of noise extracted from a sound received from the microphone A is the loudest, when a type of extracted noise feature is a human noise corresponding to a user A, the processor 130 may recognize context information where the user A is located in the vicinity of the microphone A, and recommend such that a speaker in the vicinity of the microphone A plays music corresponding to the user A based on the recognized context information. In another example, while a volume of noise extracted from a sound received from the microphone B, when a type of extracted noise feature is a cleaner noise, the processor 130 may recognize context information where a user is operating a cleaner near the microphone B, and recommend such that a speaker in the vicinity of the microphone B plays Rock music based on the recognized context information.

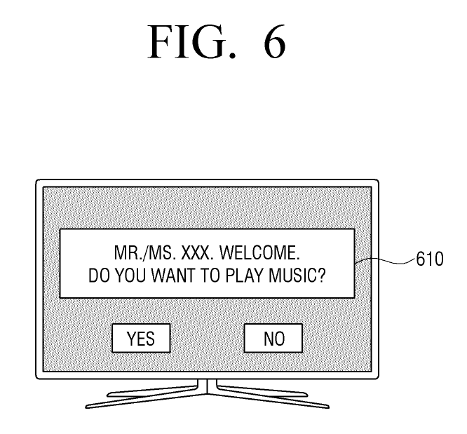

In addition, the processor 130 may analyze a type of noise feature in real time, and recognize context information according to a change of noise feature to recommend a service. For example, while a noise feature has not been extracted for a predetermined time, when a predetermined noise feature is extracted, the processor 130 may control the display 121 to display a guide message in response to the extracting of the noise feature. For example, while a noise feature has not been extracted for a predetermined time, when a human noise corresponding to a user A is extracted, the processor 130 may recognize context information where the user A has entered a house, and control the display 121 to display a guide message 601 for the user A based on the recognized context information as shown in FIG. 6. In this example, to more accurately determine context, the processor 130 may detect not only a noise feature but also the fact that the user A has entered the house through a proximity sensor positioned at a front door in the detector 180.

In addition, while a noise feature of a first type is extracted, when a noise feature of a second type is extracted, the processor 130 may recognize context information based on a change of type of noise feature, and recommend a service based on the recognized context information. For example, while a human noise corresponding to the user A is extracted, when a human noise corresponding to a user B is detected, the processor 130 may recognize context information where both the user A and the user B are at the house, and recommend music service which outputs music corresponding to both the user A and the user B.

In addition, when a complex noise feature including two more noise feature is extracted, the processor 130 may determine corresponding to the complex noise feature, and recommend a service corresponding to the determined context information. For example, when a human noise feature corresponding to the user A and a device noise feature corresponding to a cleaner are extracted, the processor 130 may determine that the user A is operating the cleaner, and recommend a music service which reproduces a favorite Rock music of the user A.

In addition, while a complex noise feature is extracted, when one noise feature included in the complex noise feature is removed, or a new noise feature is added, the processor 130 may determine context information according to a change of the changed noise feature, and recommend a service corresponding to the determined context information. For example, while a human noise feature corresponding to the user A and a device noise feature corresponding to a cleaner are extracted, when the device noise corresponding to the cleaner is extracted and only the human noise corresponding to the user A is extracted, the processor 130 may recognize context information that the user A stopped operating of the cleaner, stop playing of the favorite Rock music of the user A, and recommend a music service which reproduces a favorite Ballad music of the user A. In addition, while a human noise feature corresponding to the user A and a device noise feature corresponding to the cleaner are extracted, when an environment noise corresponding to a construction site is newly extracted, the processor 130 may recognize context information that a construction is started outside, and control the display 121 to display a guide message to close the door.

In addition, while a service is recommended, when a user shows an intention to use the service, the processor 130 may immediately perform a service corresponding to the use intention. For example, when a user action of lifting a remote controller or approaching to or touching the display 121 is sensed by the sensor 180, the processor 130 may activate the display 121 or the speaker 123, and control the functional unit to perform the recommended service.

It is described in the above-mentioned example that a service is recommended according to a type of noise feature or a change of noise feature and then, when a user command is received, a recommended service is performed. However, this is merely an example. A service according to a type of noise feature or a change of noise feature may be immediately performed without a user input.

It is described in the above-mentioned example that the electronic apparatus 100 directly provides a service based on the determined type of noise feature or the determined context information. However, this is merely an example. The electronic apparatus 100 may generate a control command based on a type of noise feature or context information, and transmit the control command to an external apparatus.

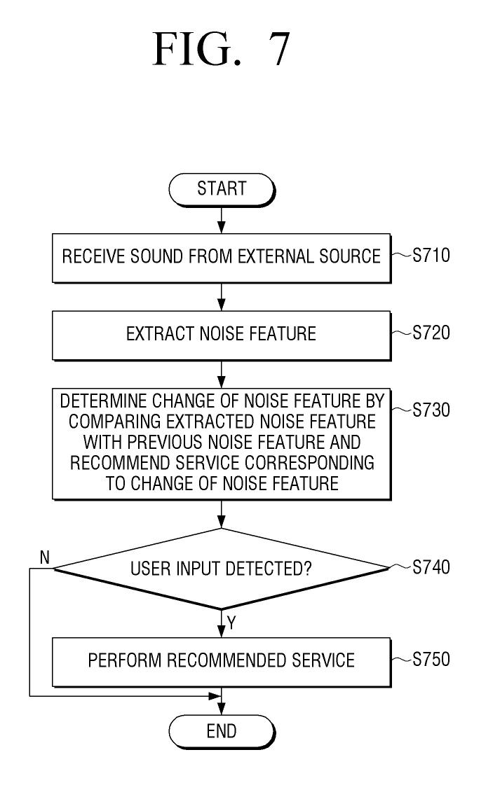

FIG. 7 is a flowchart explaining a controlling method of an electronic apparatus 100, according to an embodiment.

First, the electronic apparatus 100 receives sound from an external source through a microphone, at step S710. In this example, the electronic apparatus 100 may receive sound from an external source through a plurality of microphones.

In addition, the electronic apparatus 100 extracts a noise feature from the received sound, at step S720.

In addition, the electronic apparatus 100 may compare the extracted noise feature with a previous noise feature, and recommends service corresponding to a change of noise feature, at step S730. For example, the electronic apparatus 100 may determine a type of noise feature by comparing the extracted noise feature and the pre-stored noise feature, determine a location of a sound source which generates noise through a plurality of microphones, and determine a change of noise feature by analyzing a noise feature in real time. In addition, the electronic apparatus 100 may determine context information based on at least one of the determined type of noise feature type, location of sound source and change of noise feature, and recommend service according to the determined context information.

In addition, the electronic apparatus 100 determines whether a user input is sensed, at step S740. In this example, the electronic apparatus may detect an explicit input of a user (e.g. an input to select a YES or OK button in a remote controller). However, this is merely an example. The electronic apparatus 100 may also detect a motion intended to control the electronic apparatus 100 by a user (e.g. a user motion to lift a remote controller or approach or touch the display 121 by the detector 180).

When a user input is detected, Yes in step S740, the electronic apparatus 100 performs a recommended service according to a user input, at step S750.

According to the various embodiments of the present disclosure, the electronic apparatus may analyze a surrounding sound to extract a noise feature, thereby more accurately and promptly recognizing a surrounding context to provide a service.

A service providing method of an electronic apparatus according to the above-described various exemplary embodiments may be realized as a program and provided in a display apparatus or an input apparatus. A non-transitory computer readable medium, which stores a program including a controlling method of a display apparatus, may be provided.

The non-transitory computer readable storage medium refers to a medium that is capable of storing data semi-permanently rather than storing the data for the short period of time like register, cache, memory, and so on, and that is machine-readable. Specifically, the non-transitory readable medium may be CD, DVD, hard disk, Blu-ray disk, USB, memory card, ROM, etc.

While the present disclosure has been shown and described with reference to various embodiments thereof, it will be understood by those skilled in the art that various changes in form and t details may be made therein without departing from the spirit and scope of the present disclosure as defined by the appended claims and their equivalents.

Although a few embodiments have been shown and described, it would be appreciated by those skilled in the art that changes may be made in these embodiments without departing from the principles and spirit thereof, the scope of which is defined in the claims and their equivalents.

What is claimed is:

1. A service providing method of an electronic apparatus, the method comprising:
receiving sound through at least one microphone;
extracting a noise feature from received sound;
determining a change of the noise feature by comparing an extracted noise feature with a previously-extracted noise feature, and recommending a service corresponding to the change of the noise feature determined; and
performing the service recommended based on a user input.

2. The method as claimed in claim 1, wherein the recommending comprises:
determining a type of noise feature by comparing the extracted noise feature with a pre-stored noise feature; and
recommending the service by determining context information based on a determined type of the noise feature and a type of a previously-extracted noise feature.

3. The method as claimed in claim 1, wherein the recommending comprises, in response to determining, as a result of the determining the change of the noise feature, that a human noise has been generated by a person at a house where the electronic apparatus is located, recommending a music providing service.

4. The method as claimed in claim 1, wherein the recommending comprises, in response to determining, as a result of determining the change of the noise feature, that a device noise has been generated by a device at a house where the electronic apparatus is located, recommending a music providing service responsive to a volume of noise.

5. The method as claimed in claim 4, wherein the recommending a music providing service comprises recommending music by determining one of a genre and a volume of music being provided, according to the volume of the noise.

6. The method as claimed in claim 2, wherein the recommending the service comprises, in response to determining, as a result of determining the change of the noise feature, that an environment noise has been generated outside a house where the electronic apparatus is located, recommending an information providing service corresponding to the environment noise.

7. The method as claimed in claim 2, further comprising:
in response to a plurality of microphones being provided, determining a location of a sound source which generates the sound based on sound received through the plurality of microphones,
wherein the recommending comprises recommending a service by determining the context information based on the location of the sound source determined.

8. The method as claimed in claim 1, wherein the recommending comprises, in response to not extracting the noise feature for a predetermined time and extracting a pre-stored noise feature, recommending a guide service in response to the extracting of the noise feature.

9. The method as claimed in claim 1, wherein sound generated from outside and the user input are received by a remote controller for controlling the electronic apparatus.

10. An electronic apparatus, comprising:
at least one microphone which receives a sound generated from outside;
a processor which extracts a noise feature from received sound, determines a change of the noise feature by comparing an extracted noise feature with a previously-extracted noise feature, and recommends a service corresponding to the change of the noise feature determined; and
a functional unit which performs the service recommended according to a user input.

11. The apparatus as claimed in claim 10, wherein the processor determines a type of noise feature by comparing the extracted noise feature and a pre-stored noise feature, and recommends the service by determining context information based on a determined type of the noise feature and a previously-determined type of the noise feature.

12. The apparatus as claimed in claim 10, wherein the processor, in response to determining, as a result of determining the change of the noise feature, that a human noise has been generated by a human at a house where the electronic apparatus is located, recommends a music providing service.

13. The apparatus as claimed in claim 10, wherein the processor, in response to determining, as a result of determining the change of the noise feature, that a device noise has been generated by a device at a house where the electronic apparatus is located, recommends a music providing service in view of a volume of noise.

14. The apparatus as claimed in claim 13, wherein the processor determines one of a genre and a volume of music being provided, according to the volume of the noise.

15. The apparatus as claimed in claim 10, wherein the processor, in response to determining, as a result of determining the change of the noise feature, that an environment noise has been generated outside a house where the electronic apparatus is located, recommends an information providing service corresponding to the environment noise.

16. The apparatus as claimed in claim 11, wherein the processor, in response to a plurality of microphones being provided, determines a location of a sound source which generates the sound based on sound received through the plurality of microphones, and recommends a service by determining context information based on the location of the sound source determined.

17. The apparatus as claimed in claim 10, wherein the processor, in response to not extracting the noise feature for a predetermined time and extracting a pre-stored noise feature, recommends a guide service in response to extracting of the noise feature.

18. The apparatus as claimed in claim 10, wherein sound generated from outside and the user input are received by a remote controller for controlling the electronic apparatus.

19. A non-transitory computer readable storage medium storing a service providing method of an electronic apparatus, the method comprising:
receiving sound through at least one microphone;
extracting a noise feature from received sound;
determining a change of the noise feature by comparing an extracted noise feature with a previously-extracted noise feature, and recommending a service corresponding to the change of the noise feature determined; and
performing the service recommended based on a user input.
